(19) United States
(12) Patent Application Publication
(10) Pub. No.: US 2024/0263018 A1
(43) Pub. Date: Aug. 8, 2024

(54) COLORED TRANSLUCENT SEALANT COMPOSITION

(71) Applicant: SWIMC LLC, Cleveland, OH (US)

(72) Inventors: Jacob HUGHEY, Willoughby, OH (US); Liqun SUN, Glenwillow, OH (US); Keith E. KRESE, North Ridgeville, OH (US)

(21) Appl. No.: 18/567,815

(22) PCT Filed: Jun. 9, 2022
(86) PCT No.: PCT/US2022/032782

§ 371 Date: Dec. 7, 2023

Related U.S. Application Data
(60) Provisional application No. 63/208,715, filed on Jun. 9, 2021.

(51) Int. Cl. C09D 5/02

(52) U.S. Cl. CPC C09D 5/028

(57) ABSTRACT

The present technology provides a translucent coating. In particular, the present technology provides a colored translucent coating that can be applied to a surface such that coating appears to match the color of the surface to which the translucent coating is applied. The present translucent coatings provide a way to treat or coat different surfaces having different shades of color from one another within a color family yet still give the appearance of having the color of the particular surface to which the coating is applied.

### FIELD

The present technology relates to a coating composition and methods and applications of using such compositions. In particular, the present technology relates to colored, translucent sealant compositions that can be employed to treat a metal surface. The compositions allow for treatment of a colored metal surface without the need to specifically match the color of the surface being treated. The colored translucent sealants provide a composition that will resemble the color of the surface being treated within the same color family as that of the colored sealant.

### BACKGROUND

Metal roofs are often treated with a coating such as, for example, KYNAR® or DURANAR® and have a desired color to impart a desired appearance. Caulks, sealants, or coatings are employed for the installation of the roofing surface. Additionally, from time to time, such surfaces may become damaged or exhibit cracks such that it may become necessary to treat such surfaces with a sealant, caulk, or coating. The sealant employed to install or treat such surfaces can be either a clear sealant or a colored sealant. Clear sealants may not sufficiently mask the defects or damaged area being treated. When colored sealants are used, it is typically necessary, for aesthetic reasons, to match the color of the sealant with the color of the surface being treated. While there may be a relatively small number of primary colors that are used for to provide a surface of a particular color, there are often a large number of different tones or shades within a color family. This requires contractors or those treating or repairing the surface to carry a large number of different sealant materials of different shades or tones to be able to match the color of the sealant to the color of the surface being treated. This adds extra expense to contractors to purchase or carry the necessary volume of these different shades or tones. There is also a burden on sealant manufacturers to produce a larger inventory in terms of volume and variety of different products of different colors to cover the variety of shades or tones for a given color family. For sealant manufacturers, producing so many different shades or tones of colors can require more time and expenses to accommodate the changes required to produce the different color formulations.

### SUMMARY

The present technology relates to a sealant composition suitable for sealing or coating a coated metal substrate. The sealant composition is a colored, translucent composition that allows the color of the underlying surface to show through the sealant and still have the appearance similar to the color of the underlying surface.

The present compositions also provide a sealant in a color family that will resemble the color of a substrate to which it is applied within the color family. The present compositions, therefore, provide for a single composition of a given color that provides a “color match” for the color of the underlying surface within a color family. As such, a colored, translucent sealant composition of a particular color family can be used to treat different surfaces that have a shade or tone of color different from one another within that same color family.

In a first embodiment, provided is a colored composition comprising; a carrier; a polymeric resin; and a colorant, wherein colored coating composition is translucent or semi-transparent.

In a second embodiment in accordance with the first embodiment, the colorant is present in an amount of from about 0.00001% to about 0.02% by weight of the composition.

In a third embodiment in accordance with the first embodiment, the colorant is present in an amount of from about 0.00005% to about 0.015% by weight of the composition.

In a fourth embodiment in accordance with the first embodiment, the colorant is present in an amount of from about 0.0001% to about 0.01% by weight of the composition.

In a fifth embodiment in accordance with the first embodiment, the colorant is present in an amount of from about 0.00025% to about 0.0005% by weight of the composition.

In a sixth embodiment in accordance with any of the first through fifth embodiments, the colorant is selected from a white, gray, bronze, green, red, blue, orange, yellow, or violet colorant.

In a seventh embodiment in accordance with any of the first through sixth embodiments the colorant is a pigment selected from titanium dioxide, zinc oxide, antimony oxide, as iron oxide, carbon black, phthalocyanine blue, quinacridone red, perylene violet, lead chromate, silicochromates, barium carbonate, china clay, zinc sulfide, zirconium oxide, antimony oxide, titanium dioxide, chrome green, chrome yellow, thio-indigo red, phthalo blue, pthalo green, cobalt blue, cadmium yellow, cadmium red, toluidine red, graphite, carbon black, metallic aluminum, metallic zinc, or a combination of two or more thereof.

In an eighth embodiment in accordance with any of the first through seventh embodiments when applied to a surface having a shade of a color within the color family of the colored translucent composition, and the area of the surface to which the colored composition is applied has the appearance of the shade of the color of the underlying surface.

In an ninth embodiment in accordance with any of the first through seventh embodiments, the colored composition matches then entire pantone range of color of the color of the underlying surface. In a tenth embodiment, a white colored composition matches the entire pantone range of white. In an eleventh embodiment, a gray colored composition matches the entire pantone range of gray. In a twelfth embodiment, a red colored composition matches the entire pantone range of red. In a thirteenth embodiment, a green colored composition matches the entire pantone range of green. In a fourteenth embodiment, a blue colored composition matches the entire pantone range of blue. In a fifteenth embodiment, a bronze colored composition matches the entire pantone range of bronze.

In a sixteenth embodiment, provided is a method of treating a surface of a substrate comprising applying the colored translucent composition of any of the first through sixteenth embodiments to cover a first area of the surface having a first shade of a color within the same color family as that of the colored composition.

In a seventeenth embodiment in accordance with the sixteenth embodiment, the first area covered by the colored composition has the appearance of the first shade of the color of the first area.

In an eighteenth embodiment in accordance with the sixteenth embodiment, the method comprises applying the colored composition to a second area of the surface having a second shade of a color within the same color family as that of the colored composition, wherein the first shade is different from the second shade.

In a nineteenth embodiment in accordance with the eighteenth embodiment, the second area covered by the colored composition has the appearance of the second shade of the color of the first area.

In a twentieth embodiment in accordance with the eighteenth or nineteenth embodiment, the first shade and the second shade are in the same color family.

In a twenty-first embodiment in accordance with any of the sixteenth to twentieth embodiments, the colored composition is selected from red, green, blue, white, or gray.

In a twenty-second embodiment in accordance with the eighteenth embodiment, the colored composition is selected from white, and the first shade is a first shade of white, and the second shade is selected from a second shade of white, and the first shade is different from the second shade.

In a twenty-third embodiment in accordance with the sixteenth embodiment, the colored translucent composition is selected from gray, and the first shade is a first shade of white.

In a twenty-fourth embodiment in accordance with the eighteenth embodiment, the colored translucent composition is selected from gray, and the first shade is a first shade of white, and the second shade is selected from a second shade of white, and the first shade is different from the second shade.

In a twenty-fifth embodiment in accordance with any of the sixteenth through twenty-fourth embodiments, the surface is selected from metal, wood, plastic, or cement.

In a twenty-sixth embodiment, provided is a kit comprising two or more containers of the colored translucent composition of any the first through sixteenth embodiments, wherein the two or more colored translucent compositions have a different color from one another.

In a twenty-seventh embodiment in accordance with the twenty-sixth embodiment, the kit comprises three, four, five, or six containers of the colored translucent composition, and each of the colored translucent compositions have a different color from one another.

In a twenty-eighth embodiment in accordance with the twenty-sixth embodiment, the kit comprises: a container of a white colored translucent composition; a container of a gray colored translucent composition; a container of a red colored translucent composition; a container of a green colored translucent composition; a container of a blue colored translucent composition; and a container of a bronze colored translucent composition

In a twenty-ninth embodiment in accordance with any of the twenty-sixth through twenty-eighth embodiments, the kit comprises an applicator tool for dispensing the colored translucent compositions onto a surface.

These and other aspects and embodiments of the technology are further understood with respect to the following detailed description.

### BRIEF DESCRIPTION OF THE DRAWINGS

FIG. 1 is a photograph showing a series of panels of different colors prior to being covered with a translucent sealant in accordance with the present technology.

FIG. 2 is a photograph showing a disc coated with a translucent sealant in accordance the present technology overlying two surfaces of different colors within a color family.

FIG. 3 is a photograph showing a disc coated with a translucent sealant in accordance the present technology overlying two surfaces of different colors within a color family.

FIG. 4 compares the performance of a colored translucent coating compositions relative to a panel of a selected color.

FIG. 5 compares the performance of a colored translucent coating compositions relative to a panel of a selected color.

FIG. 6 compares the performance of a colored translucent coating compositions relative to a panel of a selected color.

FIG. 7 compares the performance of a colored translucent coating compositions relative to a panel of a selected color.

The drawings are not to scale unless otherwise noted. The drawings are for the purpose of illustrating aspects and embodiments of the present technology and are not intended to limit the technology to those aspects illustrated therein. Aspects and embodiments of the present technology can be further understood with reference to the following detailed description.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The present technology provides a coating composition suitable for treating a surface. The present technology provides a colored, translucent composition that can be used to coat or treat a surface of a substrate and resemble the color of the underlying surface. In particular, a colored, translucent composition in accordance with the present technology provides a sealant that will resemble the color of the underlying surface to which it is applied within the same color family. With the present colored, translucent compositions, a single colored translucent composition can be utilized to treat different colored surfaces within a color family and resemble the color of the different surfaces. As such, a single product is needed to treat a surface of a given color rather than having a multitude of colored sealants at hand in order to find a match. The present colored, translucent compositions provide a match within a given color family.

The coatings may be referred to herein as “translucent” or “semi-transparent.” As used herein, the term “translucent” means substantially optically transparent. As used herein, a “semi-transparent” is meant to include coating compositions that are partially transparent or are translucent, but which are not totally opaque.

The present compositions include a carrier, a polymeric resin, and a colorant. Each of such ingredients may comprise a single component or several different components. The polymeric resin is selected to provide a substantially clear composition upon curing or drying, and the colorant is provided in a concentration such that the coating material is substantially translucent or transparent.

The polymeric resin is not particularly limited and can be selected as desired to provide a coating material with the desired sealing or coating properties. Polymeric resin materials useful in coatings are well known in the art. The compositions of the present invention can include any polymer resin useful as a surface coating material (e.g., alkyds, epoxies, polyurethanes, acrylics, vinyls, hydrocarbon resins, rubbers, and the like). In the context of roof coatings, sealants, caulks, and the like, preferred polymeric resins include, without limitation, elastomeric polymers, such as thermoplastic rubbers (natural and synthetic, such as a styrene butadiene, polybutadiene, ethylene propylene, acrylonitrile butadiene, polyisoprene, etc.), thermoplastic hydrocarbon resins (e.g., thermoplastic alpha-methyl styrene polymers, hydrogenated hydrocarbon resins, etc.), and the like.

In one embodiment, the polymeric resin is a thermoplastic elastomer. Examples of suitable thermoplastic elastomers include, but are not limited to, block copolymers of an aromatic compound and an olefinic compound. Some particular examples of suitable polymeric resins include styrenic block copolymers such as, but are not limited to, styrene-ethylene butylene-styrene (SEBS), styrene-ethylene propylene-styrene (SEPS), hydrogenated polybutadiene, hydrogenated polyisoprene, hydrogenated styrene-isoprene random copolymer, styrene-ethylene propylene (SEP) block copolymer, styrene-ethylene ethylene propylene-styrene (SEEPS) and hydrogenated styrene-butadiene random copolymer.

Many styrenic block copolymers are known in the art and many block copolymers are commercially available. Examples of commercially available hydrogenated styrenic block copolymers include, but are not limited to, the polystyrene-poly(ethylene-propylene) diblock copolymers available from Kraton Polymers as KRATON G1701 and G1702; the polystyrene-poly(ethylene-butylene)-polystyrene triblock copolymers available from Kraton Polymers as KRATON G1641, G1650, G1651, G1654, G1657, G1726, G4609, G4610, GRP-6598, RP-6924, MD-6932M, MD-6933, and MD-6939; the polystyrene-poly(ethylene-butylene-styrene)-polystyrene (S-EB/S-S) triblock copolymers available from Kraton Polymers as KRATON RP-6935 and RP-6936, the polystyrene-poly(ethylene-propylene)-polystyrene triblock copolymers available from KRATON Polymers as KRATON G1730; the polystyrene-poly(ethylene-butylene)-polystyrene triblock copolymer comprising 67 weight percent polystyrene available from Asahi Kasei Elastomer as TUFTEC H1043; the polystyrene-poly(ethylene-butylene)-polystyrene triblock copolymer comprising 42 weight percent polystyrene available from Asahi Kasei Elastomer as TUFTEC H1051; the polystyrene-poly(butadiene-butylene)-polystyrene triblock copolymers available from Asahi Kasei Elastomer as TUFTEC P1000 and P2000; the polystyrene-polybutadiene-poly(styrene-butadiene)-polybutadiene block copolymer available from Asahi Kasei Elastomer as S.O.E.-SS L601; the polystyrene-poly(ethylene-butylene)-polystyrene triblock copolymer comprising about 60 weight percent polystyrene available from Kuraray as SEPTON S8104; the polystyrene-poly(ethylene-ethylene/propylene)-polystyrene triblock copolymers available from Kuraray as SEPTON 54044, 54055, 54077, and 54099; and the polystyrene-poly(ethylene-propylene)-polystyrene triblock copolymer comprising about 65 weight percent polystyrene available from Kuraray as SEPTON S2104. Mixtures of two or more block copolymers may be used. Illustrative commercially available unhydrogenated block copolymers include the KRATON D series polymers, including KRATON D1101 and D1102, from Kraton Polymers, and the styrene-butadiene radial teleblock copolymers available as, for example, K-RESIN KR01, KR03, KR05, and KR10 sold by Chevron Phillips Chemical Company. In another embodiment, the styrenic block copolymer is a mixture of high melt viscosity SEBS block copolymer and a functionalized SEBS block copolymer.

Other suitable resin materials include aliphatic hydrocarbon resin such as a hydrogenated polyolefin having 6 to 20 carbon atoms, a hydrogenated terpene resin, a rosin ester, a hydrogenated rosin glycerol ester, or a combination thereof. Tackifying agents are commercially available. Aliphatic hydrocarbon resins are exemplified by ESCOREZ 1102, 1304, 1310, 1315, and 5600 from Exxon Chemical and Eastotac resins from Eastman, such as Eastotac H-100 having a ring and ball softening point of 100° C., Eastotac H-115E having a ring and ball softening point of 115° C., and Eastotac H-130L having a ring and ball softening point of 130° C. Hydrogenated terpene resins are exemplified by Arkon P 100 from Arakawa Chemicals and Wingtack 95 from Goodyear. Hydrogenated rosin glycerol esters are exemplified by Staybelite Ester 10 and Foral from Hercules. Examples of commercially available polyterpenes include Piccolyte A125 from Hercules. Examples of aliphatic/aromatic or cycloaliphatic/aromatic resins include ECR 149B or ECR 179A from Exxon Chemical.

The polymeric resin can be provided in an amount as desired to provide a coating of desired properties or characteristics including, but not limited to, film formation, spreadability, set up or curing, etc. The polymeric resin can be provided by a combination of two or more polymeric resins as desired. In embodiments, the polymeric resin is present in an amount of from about 25 percent by weight to about 65 percent by weight based on the weight of the composition, from about 30 percent by weight to about 60 percent by weight based on the weight of the composition, from about 35 percent by weight to about 55 percent by weight based on the weight of the composition, or from about 40 percent by weight to about 50 percent by weight based on the weight of the composition.

The coating composition may include a carrier component. The carrier is a fluid component which serves to carry all of the other composition components. The carrier is part of the wet composition and usually evaporates as the composition forms a film and dries on a surface. The carrier is usually an organic solvent, including but not limited to, alkylene carbonates, aliphatics, aromatics, alcohols, ketones, ethers, glycols, etc. In one embodiment, the organic solvent will typically be one or more of aliphatic hydrocarbons or aromatic hydrocarbons, such as pentane, hexane, heptane, octane, nonane, decane or cyclic hydrocarbons, such as cyclohexane, methyl cyclohexane, cyclooctane, cyclopentane, cyclopentane, cycloheptane, cyclononane, cyclodecane, benzene, toluene, ethyl benzene and mixtures thereof. Such liquid aromatic hydrocarbons typically comprise mixtures of alkyl-substituted phenyl compounds, such as toluene (monomethyl substituted), xylenes (dimethyl substituted), cumene (isopropyl substituted), pseudocumene (1,2,4 trimethyl substituted), and the like. Suitable aliphatic hydrocarbon solvents include, but are not limited to, mineral spirits (also known as Napthol Spirits, Stoddard Solvent or white spirit), and the like. Mineral spirits are generally colorless mixtures of C7 to C12 hydrocarbons.

Non-limiting examples of materials suitable as a carrier include, for example, dimethyl carbonate, Oxsol® 100, Mineral Spirits, and Aromatic Naptha 100, acetone, methyl acetate, tert-butyl acetate, methylene chloride, volatile methyl siloxanes, perchloroethylene, and parachlorobenzotrifluoride (PCBTF).

In embodiments, the compositions have a low volatile organic content (VOC). Low VOC can be achieved through the use of non-volatile solvents and/or solvents that are exempt from calculation or consideration with respect to VOC.

The amount and type of carrier is usually determined by features of the other coating composition components. In an embodiment, the amount of carrier may range 35 percent by weight to about 75 percent by weight based on the weight of the composition, from about 40 percent by weight to about 70 percent by weight based on the weight of the composition, from about 45 percent by weight to about 65 percent by weight based on the weight of the composition, or from about 40 percent by weight to about 50 percent by weight based on the weight of the composition. It will be appreciated that a plurality of carrier materials may be employed in the compositions and may include different carriers from within a given category (e.g., different alkylene carbonates) and/or carriers from different categories or classes of materials.

The composition can be provided as a clear base composition to which the colorant is added. The base composition can be provided by the desired polymeric resin, carrier, and optional additives. Examples of suitable base compositions include those such as, but not limited to, Geocel® 2300, Geocel® 4300, and the like.

The composition includes a colorant. “Colorant” as used herein refers to a material that imparts color to a paint product. Colorants may be a combination of a liquid and a pigment that may absorb light at certain wavelengths to impart color, or colorants may reflect light at certain wavelengths to provide color to the viewer. Exemplary colorants for paints and coatings are: ColorCast Ecotoner® Colorants, NovoColor™ Colorants, Aurasperse Colorants®, Gennex® Colorants, Colortrend® Colorants, and the like. “Pigment” as used herein refers to a material that produces the color of reflected or transmitted light as the result of wavelength-specific absorption as opposed to fluorescence, phosphorescence, and other forms of luminescence, in which a material emits light. Many materials selectively absorb certain wavelengths of light.

In one embodiment, the colorant is selected to provide a desired color for the coating/sealant composition. The color of the coating is not particularly limited and can be selected as desired for a particular purpose or end use. In one embodiment the colorant is selected to provide a coating with a color such as, but not limited to, white, gray, bronze, green, red, blue, orange, yellow, violet, and the like. Pigment components useful herein to provide the colorant include those conventionally used in the coatings industry. Representative pigments include white pigments such as titanium dioxide, zinc oxide, antimony oxide, etc. and also include organic or inorganic chromatic pigments such as iron oxide, carbon black, phthalocyanine blue, quinacridone red, perylene violet, lead chromate, silicochromates, barium carbonate, china clay, zinc sulfide, zirconium oxide, antimony oxide, titanium dioxide, chrome green, chrome yellow, thio-indigo red, phthalo blue, pthalo green, cobalt blue, cadmium yellow, cadmium red, toluidine red, graphite, carbon black, metallic aluminum, metallic zinc, etc. The pigments may be combined as desired in the necessary amounts to provide the appropriate color. Additionally, multiple colorants can be employed to provide a desired color for the composition.

The colorant is provided in a concentration such that the sealant composition is pigmented but still substantially translucent such that the surface to which the composition is applied will still be visible upon curing or drying of the composition. In one embodiment, the colorant is provided in an amount of from about 0.00001% to about 0.02% by weight of the composition; from about 0.00005% to about 0.015% by weight of the composition; from about 0.0001% to about 0.01% by weight of the composition; from about 0.0001% to about 0.0075% by weight of the composition; 0.00025% to about 0.005% by weight of the composition; from about 0.0005% to about 0.0025% by weight of the composition; or from about 0.00075% to about 0.001% by weight of the composition.

In one embodiment, the composition is a translucent white comprising a white colorant is provided in an amount of from about 0.00001% to about 0.02% by weight of the composition; from about 0.00005% to about 0.015% by weight of the composition; from about 0.0001% to about 0.01% by weight of the composition; from about 0.0001% to about 0.0075% by weight of the composition; 0.00025% to about 0.005% by weight of the composition; from about 0.0005% to about 0.0025% by weight of the composition; or from about 0.00075% to about 0.001% by weight of the composition.

In one embodiment, the composition is a translucent gray comprising a gray colorant is provided in an amount of from about 0.00001% to about 0.02% by weight of the composition; from about 0.00005% to about 0.015% by weight of the composition; from about 0.0001% to about 0.01% by weight of the composition; from about 0.0001% to about 0.0075% by weight of the composition; 0.00025% to about 0.005% by weight of the composition; from about 0.0005% to about 0.0025% by weight of the composition; or from about 0.00075% to about 0.001% by weight of the composition.

In one embodiment, the composition is a translucent bronze comprising a bronze colorant is provided in an amount of from about 0.00001% to about 0.02% by weight of the composition; from about 0.00005% to about 0.015% by weight of the composition; from about 0.0001% to about 0.01% by weight of the composition; from about 0.0001% to about 0.0075% by weight of the composition; 0.00025% to about 0.005% by weight of the composition; from about 0.0005% to about 0.0025% by weight of the composition; or from about 0.00075% to about 0.001% by weight of the composition.

In one embodiment, the composition is a translucent green comprising a green colorant is provided in an amount of from about 0.00001% to about 0.02% by weight of the composition; from about 0.00005% to about 0.015% by weight of the composition; from about 0.0001% to about 0.01% by weight of the composition; from about 0.0001% to about 0.0075% by weight of the composition; 0.00025% to about 0.005% by weight of the composition; from about 0.0005% to about 0.0025% by weight of the composition; or from about 0.00075% to about 0.001% by weight of the composition.

In one embodiment, the composition is a translucent blue comprising a blue colorant is provided in an amount of from about 0.00001% to about 0.02% by weight of the composition; from about 0.00005% to about 0.015% by weight of the composition; from about 0.0001% to about 0.01% by weight of the composition; from about 0.0001% to about 0.0075% by weight of the composition; 0.00025% to about 0.005% by weight of the composition; from about 0.0005% to about 0.0025% by weight of the composition; or from about 0.00075% to about 0.001% by weight of the composition.

In one embodiment, the composition is a translucent red comprising a red colorant is provided in an amount of from about 0.00001% to about 0.02% by weight of the composition; from about 0.00005% to about 0.015% by weight of the composition; from about 0.0001% to about 0.01% by weight of the composition; from about 0.0001% to about 0.0075% by weight of the composition; 0.00025% to about 0.005% by weight of the composition; from about 0.0005% to about 0.0025% by weight of the composition; or from about 0.00075% to about 0.001% by weight of the composition.

The present compositions may include a variety of other additives as may be desired to impart certain desired characteristics or properties to the compositions. The additives may typically be included in any appropriate level in the composition. However, even at relatively low levels in the coating composition formulation, the additives may contribute to various properties of the composition, including, but not limited to, rheology, stability, paint performance, and application quality. Examples of additives that may be included in the coating composition, include, but are not limited to, resin additives, performance additives, dispersing aids, anti-settling aids, wetting aids, additional thickeners, adhesion promoters, extenders, plasticizers, stabilizers, light stabilizers, antifoams, defoamers, catalysts, rheology modifiers, rheology additives, biocides including microbiocides and/or fungicides, texture-improving agents, UV-absorbers, anticorrosive agents, anti-slip aggregates, pigments, color indicators, and/or antifluccoulating agents. In one embodiment, the composition may include benzophenone as an additive.

Functional additive and stabilizer materials are well known in the surface coating arts. The choice of which functional additives to include, if any, will depend upon the overall properties desired for a given composition. Stabilizers include, but are not limited to, antioxidants, light and UV absorbers/stabilizers, heat stabilizers, metal deactivators, free radical scavengers, carbon black, and antifungal agents. In one embodiment, the stabilizer material is selected from an antioxidant (e.g., butylated hydroxy toluene, etc.), a light stabilizer (e.g., an aromatic, heterocyclic, or heteroaromatic material such as TINUVIN (k brand stabilizers available from BASF, Ludwigshafen, Germany, etc.), a surfactant (e.g., an anionic surfactant such as a fatty alcohol sulfonate or a fatty acid salt, a cationic surfactant such as 3-(1sodecyloxy)-1-propanamine acetate, or non-ionic surfactant such as a polyethylene glycol, etc.), a plasticizer, a dispersant such as an anionic or cationic polymer, a preservative (e.g., a biocide such as an isothiazolinone, an iodinated hydrocarbon, an aromatic alcohol, etc.), and the like, in quantities sufficient to achieve their desired effect on the properties of the composition. In one embodiment, the stabilizer is an ester of a hindered phenol. “Ester of a hindered phenol,” as used to define one of the components, is intended to cover compounds based on a hindered phenol nucleus (a phenolic structure flanked by two ortho sterically hindering groups, such as t-butyl) which contains an ester substituent, such as —CH₂CH₂C(O)OR, where R can be long chain alkyl, such as C₁₆-C₁₈. In one embodiment, the stabilizer is octadecyl 3,5-di-tert-butyl-4-hydroxyhydrocinnamate, which is commercially available as IRGANOX 1076 from Ciba Geigy. In other embodiments, more than one stabilizer is used. For example, in one embodiment, the gel contains a mixture of IRGANOX 1076, IRGANOX B225 (Ciba), TINUVIN 327 (Ciba), and METASOL TK-100 (Lanxess). In some embodiments, the stabilizer or stabilizers are present at 1.0 weight percent to 3.0 weight percent of the second set of components. In other embodiments, the stabilizers are 1.0 weight percent to 3.0 weight percent of the first set of components.

As the compositions may be solvent based, it may be desirable to include an adhesion promoter to facilitate adhesion of the sealant to the surface. The adhesion promoter is not particularly limited and can be selected as desired for a particular purpose or intended application. Examples of adhesion promoters include, but are not limited to, N-cyclohexylaminomethylmethyldiethoxysilane, N-cyclohexylaminomethyltriethoxysilane, N-phenylaminomethyltrimethoxysilane, N-(2-aminoethyl)-3-aminopropyltrimethoxysilane, N-(2-aminoethyl)-3-aminopropyltrimethoxysilane, N-cyclohexyl-3-aminopropyltrimethoxysilane, 3-aminopropyltriethoxysilane, N-(2-aminoethyl)-3-aminopropylmethyldimethoxysilane, 3-aminopropyltrimethoxysilane, 3-ureidopropyltrimethoxysilan, vinylbenzylaminoethylaminopropyltrimethoxysilane, aminopropyltriethoxysilane, aminoethylaminopropyltrimethoxysilane, aminoethylaminopropyltrimethoxysilane, aminoethylaminopropyltrimethoxysilane such as, for example, DOW CORNING® Z-6121 SI LANE of Dow, aminoethylaminopropylsilanetriol homopolymer such as, for example, DOW CORNING® Z-6137 SILANE of Dow, bis(3-triethoxysilylpropyl)amine, bis(3-trimethoxysilylpropyl)amine, oligoaminosilanes such as, for example, Dynasylan® 1133 of the Degussa company, aminosilane compositions such as, for example, Dynasylan® 1204, Dynasylan® AMEO-T, Dynasylan® SIVO 210, Dynasylin® DAMO-M, Dynasylin® DAMO-T of the Degussa company, 3-aminopropylmethyldiethoxysilane, 3-aminopropylmethyldiethoxysilane formulations such as, for example, Dynasylan® 1506 of the Degussa company, 3-aminopropyltriethoxysilane, 3-aminopropyltrimethoxysilane, aqueous siloxanes, VOC-free (i.e. free of volatile organic compounds) such as, for example, Dynasylan® HYDROSIL 1151, Dynasylan® HYDROSIL 2627, Dynasylan® HYDROSIL 2909, Dynasylan® HYDROSIL 2929, Dynasylan® HYDROSIL 2776 of the Degussa company, triaminofunctional propyltrimethoxysilanes such as, for example, Dynasylan® TRIAMO of the Degussa company, oligosiloxanes such as, for example, Dynasylan® 1146 of the Degussa company, N-(n-butyl)-3-aminopropyltrimethoxysilane, cationic benzylamino-functional silane hydrochloride such as, for example, Dynasylan® 1161 of the Degussa company, 2-aminoethyl-3-aminopropylmethyldimethoxysilane, 2-aminoethyl-3-aminopropyltrimethoxysilane, gamma-aminopropyltriethoxysilane, modified aminoorganosilanes such as, for example, Silquest® A-1108 of Momentive Performance Materials, gamma-aminopropyltrimethoxysilane, N-beta-(aminoethyl)-gamma-aminopropyltrimethoxysilane, modified aminoorganosilanes such as, for example, Silquest® A-1126 or A-1128 of Momentive Performance Materials, triamino-functional silanes such as, for example, Silquest® A-1130 of Momentive Performance Materials, bis-(gamma-trimethoxysilylpropyl)amine, polyazamidesilane such as, for example, Silquest® A-1387 of Momentive Performance Materials, delta-aminoneohexyltrimethoxysilane, N-beta-(aminoethyl)-gamma-aminopropylmethyldimethoxysilane, delta-aminoneohexylmethyldimethoxysilane, and N-phenyl-gamma-aminopropyltrimethoxysilane.

The concentrations of any included functional additives arc selected to be sufficient to provide the desired effect on the property of interest. The selection of a functional additive and the concentration of any such additive is generally within the level of ordinary skill in the surface coating formulation arts. The amount and type of additives are usually determined by features of the other coating composition components. In an embodiment, the amount of additives may range from about 0.01 weight percent to about 20 weight percent, from about 2 to about 17 weight percent, from about 5 to about 15 weight percent, and even from about 8 to about 14 weight percent of the composition.

The coating composition can be prepared by mixing any or all of the following materials: the carrier, polymeric resin, colorant, and any optional additives. In one embodiment, a base composition is prepared by mixing the respective carrier, polymeric resin, colorant, and optional additives. From this base composition, the respective colored translucent compositions can be prepared by adding the desired colorant in the desired concentration.

The coating composition can be applied by any suitable methods including, but not limited to, by brush, by roller, by spraying, by caulking gun or other suitable applicator or dispenser, etc. Curing can be accomplished by any suitable curing mechanism including, for example, thermal condensation.

The coating composition can be applied to provide a coating layer of a desired thickness. In one embodiment, the coating composition has a thickness of from 0.5 micrometer to about 500 micrometers; from about 1 micrometer to about 300 micrometers; and even from about 3 micrometers to about 200 micrometers.

The compositions essentially provide a system for treating colored surfaces wherein a single colored sealant composition can be employed on different surfaces (e.g., a coated metal surface) of different colors within a particular color family and give the appearance of the color of the surface to which the composition is applied. In particular the colored, translucent compositions allow for treating a metal surface having a first shade of a color within the same color family as that of the translucent composition and treating a metal surface having a second shade of a color within the same color family as that of the translucent composition (the second shade being different from the first shade), wherein the translucent composition gives the appearance of the first shade when applied to the surface bearing the first shade, and gives the appearance of the second shade when applied to the surface bearing the second shade.

In one embodiment, for example, a translucent red composition in accordance with the present composition can be provided to seal or coat a portion of a first surface having a first shade of a red color wherein the portion of the surface coated with the composition has the appearance of the first shade of the red color. The translucent red composition can also be provided to seal or coat a portion of a second surface having a second shade of a red color (different from the first shade) wherein the portion of the surface coated with the composition has the appearance of the second shade of the red color.

In another embodiment, for example, a translucent green composition in accordance with the present composition can be provided to seal or coat a portion of a first surface having a first shade of a green color wherein the portion of the surface coated with the composition has the appearance of the first shade of the green color. The translucent green composition can also be provided to seal or coat a portion of a second surface having a second shade of a green color (different from the first shade) wherein the portion of the surface coated with the composition has the appearance of the second shade of the green color.

In one embodiment, for example, a translucent blue composition in accordance with the present composition can be provided to seal or coat a portion of a first surface having a first shade of a blue color wherein the portion of the surface coated with the composition has the appearance of the first shade of the blue color. The translucent blue composition can also be provided to seal or coat a portion of a second surface having a second shade of a blue color (different from the first shade) wherein the portion of the surface coated with the composition has the appearance of the second shade of the blue color.

In one embodiment, for example, a translucent white composition in accordance with the present composition can be provided to seal or coat a portion of a first surface having a first shade of a white color wherein the portion of the surface coated with the composition has the appearance of the first shade of the white color. The translucent white composition can also be provided to seal or coat a portion of a second surface having a second shade of a white color (different from the first shade) wherein the portion of the surface coated with the composition has the appearance of the second shade of the white color.

In one embodiment, for example, a translucent gray composition in accordance with the present composition can be provided to seal or coat a portion of a first surface having a first shade of a white color wherein the portion of the surface coated with the composition has the appearance of the first shade of the white color. The translucent white composition can also be provided to seal or coat a portion of a second surface having a second shade of a white color (different from the first shade) wherein the portion of the surface coated with the composition has the appearance of the second shade of the white color.

It will be appreciated that a given colored translucent composition in accordance with the present technology can be used to “match” or give the appearance of a color of the surface to which the composition is applied for multiple shades within a color family. A colored translucent composition could “match” 2, 5, 10, 15, 20, 25, or 30 or more shades within the same color family. In embodiments, a white colored translucent composition will match the entire pantone range of white; a gray colored translucent composition will match the entire pantone range of gray; a red colored translucent composition will match the entire pantone range of red; a green colored translucent composition will match the entire pantone range of green; a blue colored translucent composition will match the entire pantone range of blue; and a bronze colored translucent composition will match the entire pantone range of bronze.

The disclosed compositions can be provided individually as part of a kit. In one embodiment, two or more compositions of different colors are provided in a kit. In one embodiment, the kit comprises 2, 3, 4, 5, or 6 packages or containers of the coating composition wherein each package/container is of a different color. In one embodiment, the kit comprises a white composition, a gray composition, a red composition, a green composition, a blue composition, and a bronze composition. The kit may optionally include an applicator tool for dispensing or applying the compositions onto a surface. In one embodiment, the compositions are provided in caulking tubes and the kit includes a caulking gun for applying the compositions to a substrate of interest.

The disclosed sealant and coating compositions may be applied to a variety of substrates, e.g., asphalt (including asphalt composition shingles), cement, cement fiberboard, ceramics, concrete, metal, plastic and wood (including monolithic, engineered and veneered wood). The use of the substrate is not particularly limited and can be for industrial or residential applications. Non-limiting examples of such substrates include siding products, boards and the like, for uses including fencing, roofing, flooring, decking, wall boards, shower boards, lap siding, vertical siding, soffit panels, trim boards, shaped edge shingle replicas and stone or stucco replicas.

The sealant and coating compositions can be used at any stage in processing, installing, or repairing a substrate. For example, when installing panels, the panels may vary slightly in tone or shade, and the present sealants will allow for those regions of the different panels covered by the sealant to have the appearance of the underlying substrate.

The following examples are illustrative and not to be construed as limiting of the technology as disclosed and claimed herein.

### EXAMPLES

### Example 1

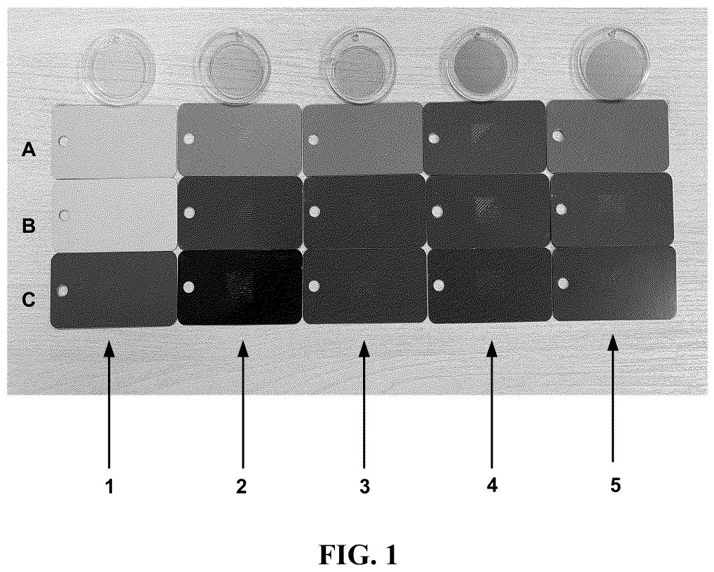

Translucent compositions in accordance with the present technology were prepared in five different colors: white, gray, green, red, and blue. The composition is prepared by adding a colorant to a base sealant composition. In the present examples, the base sealant is based on a Geocel® clear sealant composition, and adding from about 0.00001% to about 0.02% by weight of the colorant(s). Clear plastic discs were separately coated with one of the compositions to provide a circular coated area. Five sets of metal panels were provided with each set having three panels coated with a different shade within the following color palettes: white, gray, green, red, and blue. (FIG. 1.) As shown in FIG. 1, from left to right, a set of three panels (A, B, and C) with different shades or tones within a color family are provided in the respective columns:
Column 1: White color family
Column 2: Gray color family
Column 3: Green color family
Column 4: Red color family
Column 5: Blue color family

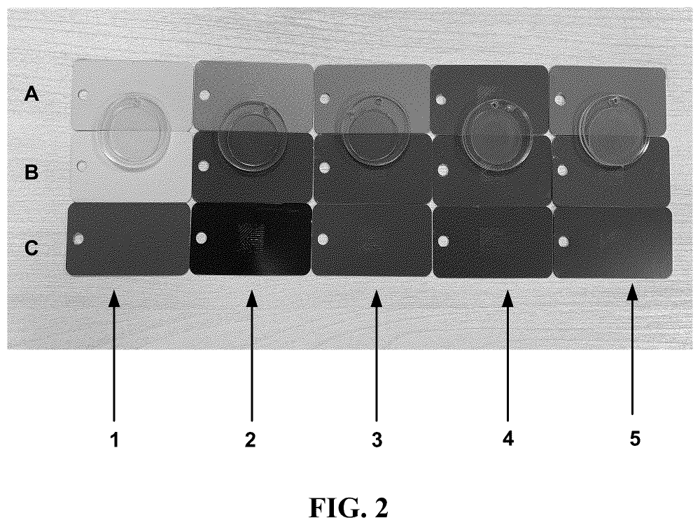

In FIG. 2, the discs coated with the colored translucent coatings are positioned between the first and second panels having a different shade of color from one another. The discs are positioned such that the translucent coating covers a portion of panel A and a portion of panel B. As shown in FIG. 2, the appearance of the respective panels in the area covered by the translucent coating matches or substantially matches the color of panel A and the color of panel B in those areas that are not coated with the translucent coating.

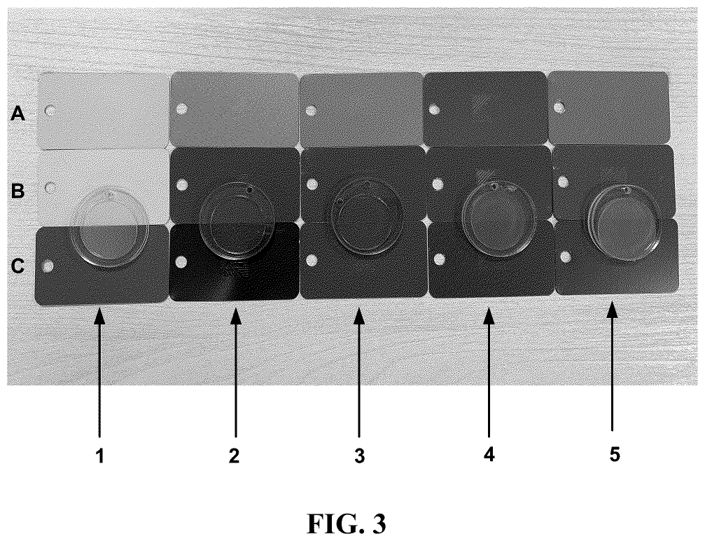

In FIG. 3, the discs coated with the translucent coatings are positioned between the panels B and C having a different shade of color from one another (and different from that of the first panels in the sets). The discs are positioned such that the translucent coating covers a portion of panel B and a portion of panel C. As shown in FIG. 3, the appearance of the respective panels in the area covered by the translucent coating matches or substantially matches the color of the panel in those areas that are not coated with the translucent coating.

FIGS. 1-3 illustrate the effect that would be observed if a region of a surface was treated or coated with the present compositions. Specifically, FIGS. 1-3 illustrate that a single colored translucent coating composition in accordance with the present technology could be employed to coat different surfaces having different shades of a color within a similar color family to match the color of the surface being treated. The present translucent coatings, therefore, can eliminate the need for contractors to carry multiple, if not dozens of, colors of sealant within a given color palette to attempt to match the color of the surface that they are treating or repairing.

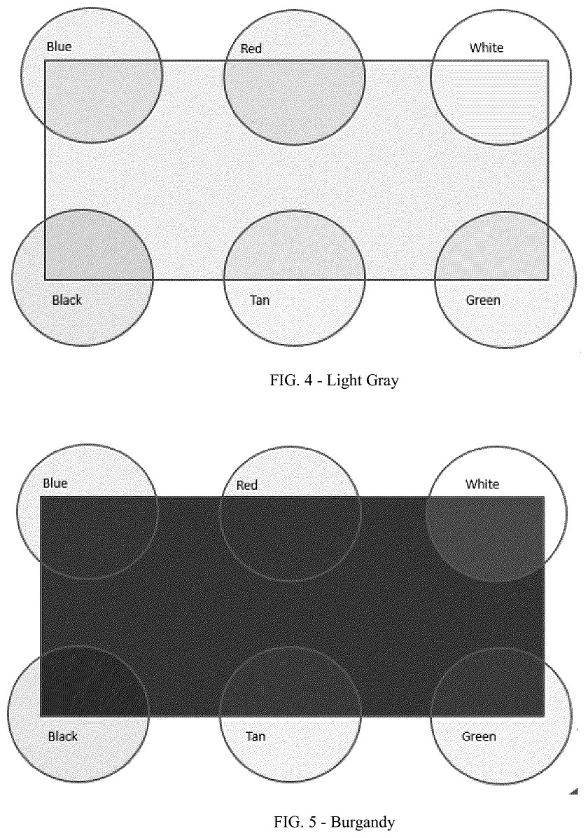

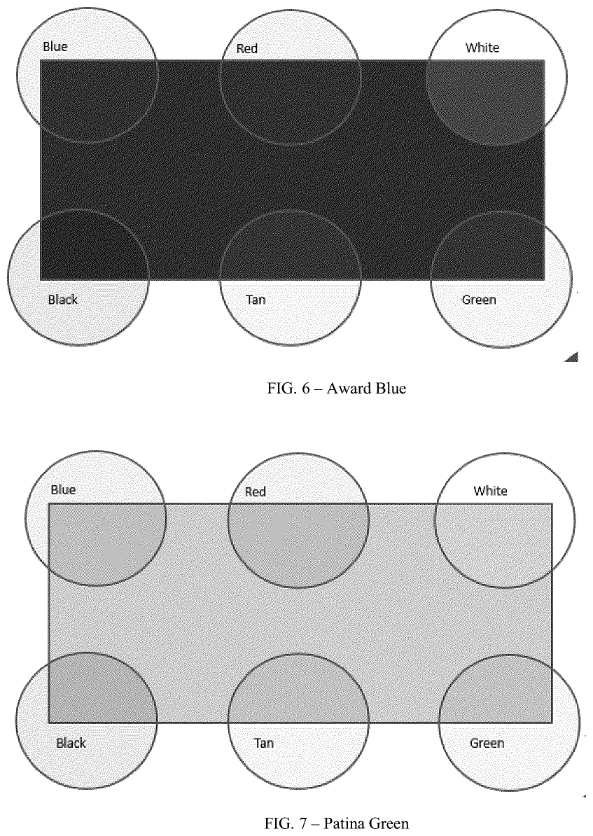

FIGS. 4-7 compares the performance of different colored translucent coating compositions relative to a panel of a selected color. With respect to the light gray panel (FIG. 4), the white colored translucent coating when overlying a region of the panel matches the color of the panel better than the other colored coatings. With respect to the burg Randy panel (FIG. 5), the red colored translucent coating when overlying a region of the panel matches the color of the panel better than the other colored coatings. With respect to the award blue panel (FIG. 6), the blue colored translucent coating when overlying a region of the panel matches the color of the panel better than the other colored coatings. With respect to the patina green panel (FIG. 7), the green colored translucent coating when overlying a region of the panel matches the color of the panel better than the other colored coatings.

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a translucent coating composition and methods and systems of using such translucent coatings. Modifications may occur to those skilled in the art and to those who may make and use the invention. The disclosed embodiments are merely for illustrative purposes and not intended to limit the scope of the invention or the subject matter set forth in the claims.

1. A colored composition comprising:
a carrier;
a polymeric resin; and
a colorant, wherein colored coating composition is translucent or semi-transparent.

2. The colored composition of claim 1, wherein the colorant is present in an amount of from about 0.00001% to about 0.02% by weight of the composition.

3. The colored composition of claim 1, wherein the colorant is present in an amount of from about 0.00005% to about 0.015% by weight of the composition.

4. The colored composition of claim 1, wherein the colorant is present in an amount of from about 0.0001% to about 0.01% by weight of the composition.

5. The colored composition of claim 1, wherein the colorant is present in an amount of from about 0.00025% to about 0.0005% by weight of the composition.

6. The colored composition of claim 1, wherein the colorant is selected from a white, gray, bronze, green, red, blue, orange, yellow, or violet colorant.

7. The colored composition of claim 1, wherein the colorant is a pigment selected from titanium dioxide, zinc oxide, antimony oxide, as iron oxide, carbon black, phthalocyanine blue, quinacridone red, perylene violet, lead chromate, silicochromates, barium carbonate, china clay, zinc sulfide, zirconium oxide, antimony oxide, titanium dioxide, chrome green, chrome yellow, thio-indigo red, phthalo blue, pthalo green, cobalt blue, cadmium yellow, cadmium red, toluidine red, graphite, carbon black, metallic aluminum, metallic zinc, or a combination of two or more thereof.

8. The colored composition of claim 1-7, wherein when applied to a surface having a shade of a color within the color family of the colored translucent, and the area of the surface to which the colored composition is applied has the appearance of the shade of the color of the underlying surface.

9. A method of treating a surface of a substrate comprising applying the colored translucent composition of claim 1 to cover a first area of the surface having a first shade of a color within the same color family as that of the colored composition.

10. The method of claim 9, wherein the first area covered by the colored composition has the appearance of the first shade of the color of the first area.

11. The method of claim 9 comprising applying the colored composition to a second area of the surface having a second shade of a color within the same color family as that of the colored composition, wherein the first shade is different from the second shade.

12. The method of claim 11, wherein the second area covered by the colored composition has the appearance of the second shade of the color of the first area.

13. The method of claim 11, wherein the first shade and the second shade are in the same color family.

14. The method of claim 9-44, wherein the colored composition is selected from red, green, blue, white, or gray.

15. The method of claim 11, wherein the colored composition is selected from white, and the first shade is a first shade of white, and the second shade is selected from a second shade of white, and the first shade is different from the second shade.

16. The method of claim 9, wherein the colored translucent composition is selected from gray, and the first shade is a first shade of white.

17. The method of claim 11, wherein the colored translucent composition is selected from gray, and the first shade is a first shade of white, and the second shade is selected from a second shade of white, and the first shade is different from the second shade.

18. The method of claim 9, wherein the surface is selected from metal, wood, plastic, or cement.

19. A kit comprising two or more containers of the colored translucent composition of claim 1, wherein the two or more colored translucent compositions have a different color from one another.

20. The kit of claim 19 comprising three, four, five, or six containers of the colored translucent composition, and each of the colored translucent compositions have a different color from one another.

21. The kit of claim 19 comprising: a container of a white colored translucent composition; a container of a gray colored translucent composition; a container of a red colored translucent composition; a container of a green colored translucent composition; a container of a blue colored translucent composition; and a container of a bronze colored translucent composition.

22. The kit of claim 19 comprising an applicator tool for dispensing the colored translucent compositions onto a surface.
